(19) United States
(12) Patent Application Publication
(10) Pub. No.: US 2014/0327159 A1
(43) Pub. Date: Nov. 6, 2014

(54) SODA MACHINE WITH A SAFETY FITTING

(71) Applicant: Ning Song, Guangzhou (CN)

(72) Inventor: Ning Song, Guangzhou (CN)

(21) Appl. No.: 14/004,891

(22) PCT Filed: Mar. 12, 2012
(86) PCT No.: PCT/EP12/54210

§ 371 Date: Jul. 10, 2014

(30) Foreign Application Priority Data
Mar. 15, 2011 (CN) 201120066571.7

(51) Int. Cl. A47J 31/58; F16K 17/04; F16K 3/24; B01F 3/04

(52) U.S. Cl. CPC A47J 31/58; B01F 3/04787; F16K 17/0473; F16K 3/24; B01F 2003/04822
USPC 261/42; 261/65

(57) ABSTRACT

A soda machine with a safety fitting, which includes a carbon dioxide steel cylinder, a soda cylinder, a gas outlet controller fitted to the carbon dioxide steel cylinder and a gas inlet fitted to the soda cylinder; said gas outlet controller includes a gas inlet body, a drive rod, a valve core and a valve core seat, the gas inlet body including a drive rod channel, a valve core seat chamber and a gas outlet hole; a limit disk being provided at a junction area of the drive rod and the valve core; and further comprising a safety valve, a gas inlet hole of the safety valve communicating to the gas outlet controller, and a gas outlet hole communicating to the gas inlet.

### FIELD OF THE INVENTION

The present invention relates to a soda machine.

### BACKGROUND OF THE INVENTION

A currently available technology for a soda machine includes a carbon dioxide steel cylinder, a soda cylinder, a gas outlet controller fitted to the steel carbon dioxide cylinder and a gas inlet means fitted to the soda cylinder; the gas outlet controller includes a gas inlet body, a drive rod, a valve core and a valve core seat; the gas inlet body includes a drive rod channel, a valve seat chamber and a gas outlet hole; the drive rod and the valve seat are integrally made, and a limit disk is provided at a junction area of the drive rod and the valve core; a lower portion of the gas inlet body is removably connected to a mouth of the carbon dioxide steel cylinder.

Current soda machines suffer drawbacks: the hole in the gas inlet means is very small; if the hole clogs abnormally and the steel cylinder does not release gas, high pressure may be created inside the gas inlet means, which is prone to explosion accident and thus poses a safety risk.

### DESCRIPTION OF THE INVENTION

The aim of the present invention is to provide a safety fitting which can effectively automatically release pressure in the event of the inlet means having a high pressure, and thus eliminate the risk to safety.

The invention is implemented as follows. A soda machine with a safety fitting, which includes a carbon dioxide steel cylinder, a soda cylinder, a gas outlet controller fitted to the carbon dioxide steel cylinder and a gas inlet means fitted to the soda cylinder; the gas outlet controller includes a gas inlet body, a drive rod, a valve core and a valve core seat, and the gas inlet body includes a drive rod channel, a valve core seat chamber and a gas outlet hole; the drive rod and the valve seat are integrally made, and a limit disk is provided at a junction area of the drive rod and the valve core; characterised in that it further includes a safety valve, and a gas inlet hole of the safety valve communicates to the gas outlet controller, and a gas outlet hole communicates to the gas inlet means.

The safety valve includes a valve body, a pressure spring, a valve core and a base cover having an outer thread, the valve body has a gas channel, and a valve core chamber perpendicular to the gas channel; the gas channel and the valve core chamber communicate to each other by means of a through hole; a pressure relief hole is provided on the valve core chamber.

The valve core includes a conical core, a base plate and a spring seat which is positioned on a bottom surface of the base plate; the conical core engages the through hole, an upper end of the pressure spring engages the pressure spring seat, and an lower end thereof engages the base cover having the outer thread.

The soda machine with the safety fitting is characterised in that it further includes a pressure adjustment valve, and a top cover of the aforementioned gas inlet means has a gas outlet aperture, which communicates to the pressure adjustment valve.

The pressure adjustment valve includes a valve housing, a drive rod, a limit nut, a gas block, an adjustment screw rod, an adjustment-fixing sleeve, a spring and a rotating knob.

The valve housing has a drive channel, a valve core chamber and an adjustment rod channel along a line; a hollow gas block seat is provided at a junction area of the drive channel and the valve core chamber, a gas inlet hole communicates to the hollow gas block seat, and a pressure relief hole is provided on the valve core chamber.

The drive rod slidably engages and hermetically seals the drive channel, a guide rod at the base of the drive rod slidably engages a central threaded hole of a limit nut, and a mandrel at a top of the drive rod extends into the hollow gas block seat with clearances fit.

The gas block slidably engages the valve core chamber, and the gas block engages the valve core seat.

The adjustment screw rod slidably engages and hermetically seals the adjustment rod channel, the adjustment-fixing sleeve is inserted into the adjustment channel, a thread of an upper portion of the adjustment screw rod is screwed to the adjustment-fixing sleeve, the limit nut engages the adjustment-fixing sleeve, a top portion of the adjustment screw rod extends beyond the limit nut, and the rotating knob is connected to the top portion of the adjustment screw rod; and the spring engages the gas block and the adjustment screw rod.

The soda machine with the safety fitting is further characterised in that a base of the valve core seat has an inner thread; and an outer wall of the valve core seat in which the inner thread is provided has an annular positioning groove;

A through embedded hole is provided in a portion of the gas inlet body engaging the valve core seat; the valve core seat is embedded into the valve core seat chamber;

This further includes a bush, a positioning ring, a steel ball and a spring; the positioning ring is fitted into the bush, the steel ball is embedded into a hole and engages the annular positioning groove; the steel ball engages the positioning ring.

The spring fits over a lower segment of the gas inlet body, a top end of the spring engages the block plate of the gas inlet body, and its bottom end engages the positioning ring.

The soda machine with the safety fitting is further characterised in that it also includes a push-button connecting rod, which is pivotally connected to a frame, and its end engages the drive rod.

The present invention relates to a soda machine with a safety fitting, whereby, when a structure of this type is used, in the event of abnormal conditions in the gas inlet means, the carbon dioxide entering the safety valve actuates the valve core downwardly, and the valve core thus moves away from the through hole, enabling the carbon dioxide to enter the valve core chamber, where it is exhausted through the pressure relief hole, eliminating the high pressure and thus the safety risk, thus achieving the safety objective.

### BRIEF INTRODUCTION TO THE DRAWINGS

FIG. 1 is a cutaway view of the soda machine according to the present invention.

FIG. 2 is a cutaway view of a safety fitting according to the present invention.

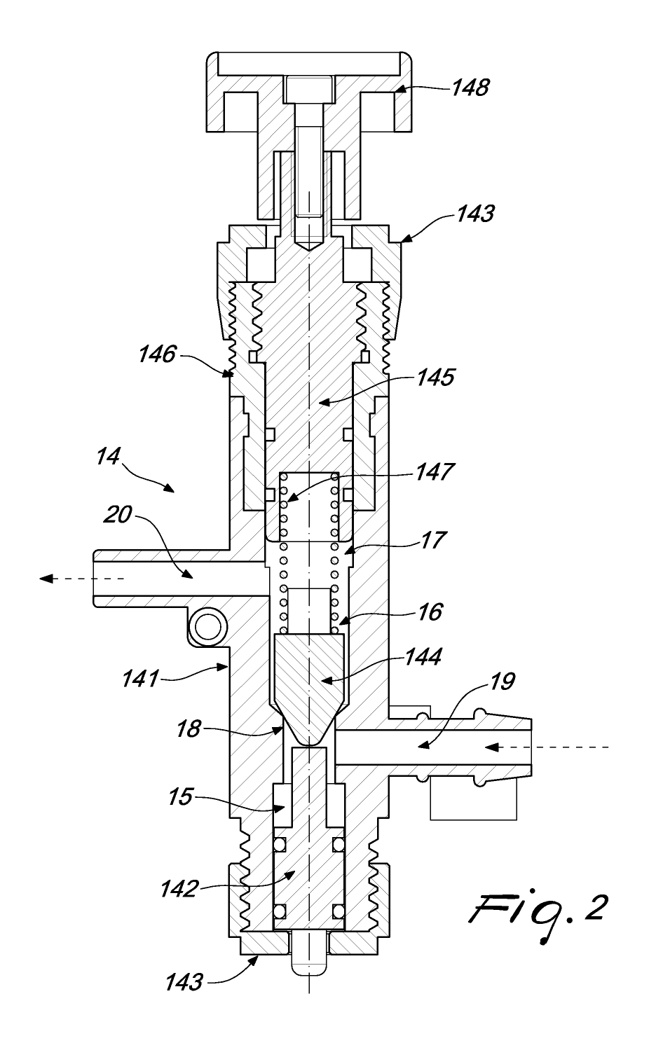

FIG. 3 is a cutaway view of a valve core of a safety valve according to the present invention.

FIG. 4 is a cutaway view of a pressure adjustment valve according to the present invention.

### DETAILED DESCRIPTION OF THE PRACTICAL EMBODIMENTS

Hereinafter, the present invention will be further described with reference to the Figures.

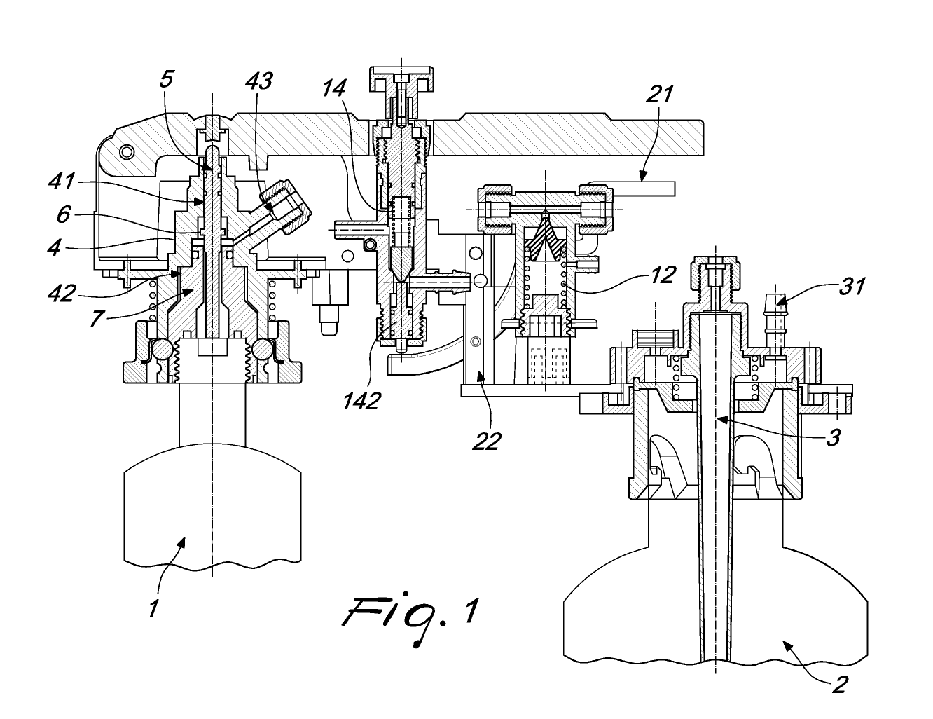

As shown in FIG. 1, a type of soda machine with a safety fitting is illustrated, which includes a carbon dioxide steel cylinder 1, a soda cylinder 2, a gas outlet controller fitted to the carbon dioxide steel cylinder 1 and a gas inlet means 3 fitted to the soda cylinder 2; the gas outlet controller includes a gas inlet body 4, a drive rod 5, a valve core 6 and a valve core seat 7, and the gas inlet body 4 includes a drive rod channel 41, a valve core seat chamber 42 and a gas outlet hole 43, and the drive rod 5 and the valve seat 6 are made of a single piece.

A base of the valve core seat 7 has an inner thread, and an outer wall of the valve core seat 7 where the inner thread is provided has an annular positioning groove.

A through embedded hole is provided in a portion of the gas inlet body 4 engaging the valve core seat; and the valve core seat 7 is embedded into the valve core seat chamber 42.

The valve core seat 7 engages a mouth of the carbon dioxide steel cylinder by means of the thread; a guide rod on the valve core 6 slidably engages a central hole in the valve core seat.

This further includes a bush 8, a positioning ring 9, a steel ball 10 and a spring 11; the positioning ring 9 is fitted into the bush 8, the steel ball 10 is embedded into a hole, and engages the annular positioning groove; the steel ball 10 engages the positioning ring 9; the spring 11 fits over a lower segment of the gas inlet body 4, an top end of the spring 11 engages a block plate of the gas inlet body 4, and its bottom end engages the positioning ring 9.

When in use, the valve core seat 7 is first connected to the carbon dioxide steel cylinder, and then the valve core seat 7 is inserted into the valve core chamber 42 of the gas inlet body 4; during the inserting operation, the steel ball 10 is embedded into the annular positioning groove, causing the gas intake body 4 to be connected to the carbon dioxide steel cylinder, enabling rapid, convenient connection. To disconnect these, the gas inlet body 4 is put upward to realize the detachment of the gas inlet body 4 from the valve core seat.

As shown in FIG. 1, this further includes a safety valve 12; and a gas inlet hole of the safety valve 12 communicates to the gas outlet controller, and a gas outlet hole communicates to the gas inlet means 3;

The safety valve 12 includes a valve body 121, a pressure spring 122, a valve core 123 and a base cover 124 with an outer thread; the valve body 121 has a gas channel 1211, and a valve core chamber 1212 perpendicular to the gas channel; the gas channel 1211 and the valve core chamber 1212 communicate to each other by means of a through hole; a pressure relief hole 1213 is provided on the valve core chamber 1212.

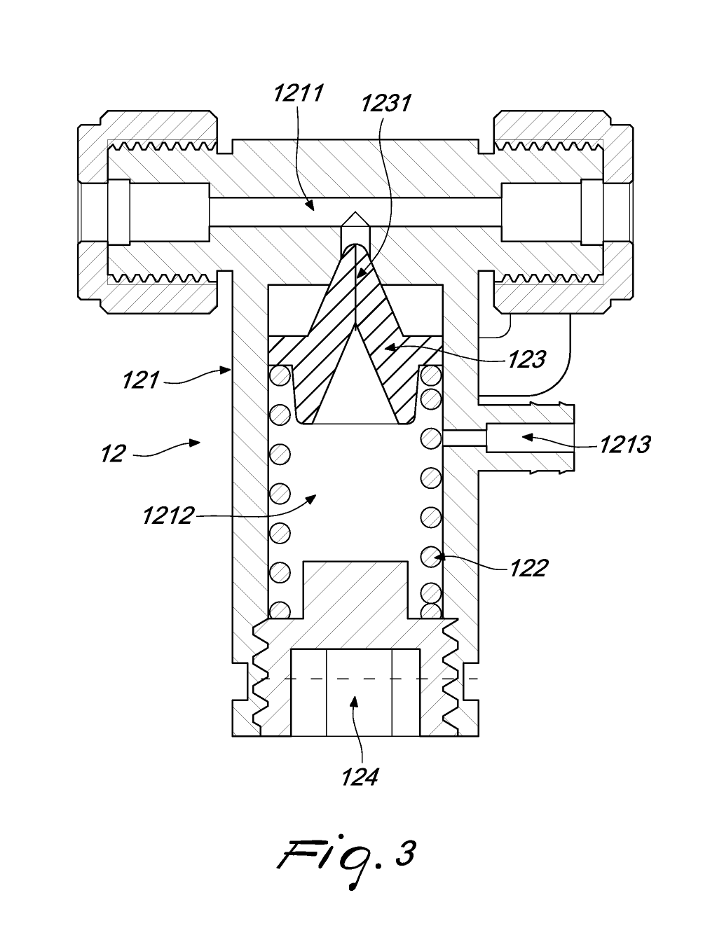

As shown in FIG. 3, the valve core 123 includes a conical core 1231, a base plate 1232 and a spring seat 1233 which is positioned on a bottom surface of the base plate; the conical core 1211 engages the through hole, the upper end of the pressure spring 122 engages the spring seat 1233, and the lower end thereof engages the base cover 124 having the outer thread; the base cover 124 having the outer thread engages with valve core chamber 1212.

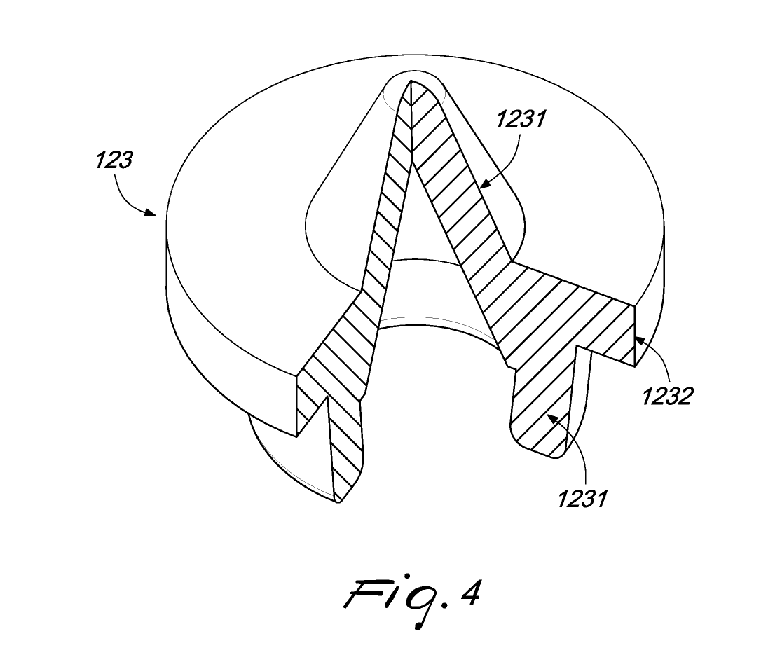

As shown in FIG. 4, this further includes a pressure adjustment valve 14, and a top cover of the gas inlet means 3 has a gas outlet aperture 31, which communicates to the pressure adjustment valve 14.

The pressure adjustment valve 14 includes a valve housing 141, a drive rod 142, a limit nut 143, a gas block 144, an adjustment screw rod 145, an adjustment-fixing sleeve 146, a spring 147 and a rotating knob 148.

The valve housing 141 has a drive channel 15, a valve core chamber 16 and an adjustment rod channel 17 along a line; a hollow gas block seat 18 is provided at a junction area of the drive channel 15 and the valve core chamber 16; a gas inlet hole 19 is connected to the hollow gas block seat 18, and a pressure relief hole 20 is provided on the valve core chamber 16.

The drive rod 142 slidably engages and hermetically seals the drive channel 15, a guide rod at the base of the drive rod 142 slidably engages a central hole of the limit nut 143, and a mandrel at a top of the drive rod 142 extends into the hollow gas block seat 18 with clearance fit.

The gas block 144 slidably engages the valve core chamber 16, and the gas block 144 engages the valve core seat 18.

The adjustment screw rod 145 slidably engages and hermetically seals the adjustment rod channel 17, the adjustment-fixing sleeve 146 is inserted into the adjustment rod channel 17, a thread of an upper portion of the adjustment screw rod 145 is screwed to the adjustment-fixing sleeve 146, the limit nut 143 engages the adjustment-fixing sleeve 146, a top portion of the adjustment screw rod 145 extends beyond the limit nut 143, and the rotating knob 148 is connected to the top portion of the adjustment screw rod 145; the spring 147 engages the gas block 144 and the adjustment screw rod 145.

As shown in FIG. 1, this further includes a push-button connecting rod 21, which is pivotally connected to a frame 22, and its end engages the drive rod 142.

The above description relates to a preferred embodiment of the invention. It should be noted that those ordinary skilled in the art will be able to device a number of improvements and variations, which should also be deemed to be included in the scope of the present invention, which is defined by the herewith appended claims.

The disclosures in Chinese Utility Model No. 201120066571.7 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-4. (canceled)

5. A soda machine with a safety fitting, which includes a carbon dioxide steel cylinder, a soda cylinder, a gas outlet controller fitted to the carbon dioxide steel cylinder and a gas inlet means fitted to the soda cylinder; said gas outlet controller includes a gas inlet body, a drive rod, a valve core and a valve core seat, the gas inlet body including a drive rod channel, a valve core seat chamber and a gas outlet hole; the drive rod and the valve core seat being made of a single piece, and a limit disk being provided at a junction area of the drive rod and the valve core; further comprising a safety valve, a gas inlet hole of the safety valve communicating to the gas outlet controller, and a gas outlet hole communicating to the gas inlet means;
said safety valve including a valve body, a pressure spring, a valve core and a base cover having an outer thread, said valve body having a gas channel, and a valve core chamber perpendicular to the gas channel; the gas channel and the valve core chamber communicating to each other by means of a through hole; a pressure relief hole being provided on the valve core chamber;
said valve core including a conical core, a base plate and a spring seat which is positioned on a bottom surface of the base plate; the conical core engaging the through hole, an upper end of the pressure spring engaging the pressure spring seat, and an lower end thereof engaging the base cover having the outer thread.

6. The soda machine according to claim 5, further including a pressure adjustment valve, and a top cover of said gas inlet means has a gas outlet aperture, which communicates to the pressure adjustment valve;
said pressure adjustment valve including a valve housing, a drive rod , a limit nut, a gas block, an adjustment screw rod, an adjustment-fixing sleeve, a spring and a rotating knob,
said valve housing having a drive channel, a valve core chamber and an adjustment rod channel along a line; a hollow gas block seat being provided at a junction area of the drive channel and the valve core chamber, a gas inlet hole communicating to the hollow gas block seat, and a pressure relief hole being provided on the valve core chamber;
said drive rod slidably engaging and hermetically sealing the drive channel, a guide rod at a base of the drive rod slidably engaging a central threaded hole of the limit nut, and a mandrel at a top of the drive rod extending into the hollow gas block seat with clearances fit;
the gas block slidably engaging the valve core chamber, and the gas block engaging the valve core seat;
the adjustment screw rod slidably engaging and hermetically sealing the adjustment rod channel, the adjustment-fixing sleeve being inserted into the adjustment rod channel, a thread of an upper portion of the adjustment screw rod being screwed to the adjustment-fixing sleeve, the limit nut engaging the adjustment-fixing sleeve, a top portion of the adjustment screw rod extending beyond the limit nut, and the rotating knob being connected to the top portion of the adjustment screw rod; and the spring engaging the gas block and the adjustment screw rod.

7. The soda machine according to claim 5, wherein a base of said valve core seat has an inner thread; and an outer wall of the valve core seat where the inner thread is provided has an annular positioning groove;
a through embedded hole being provided in a portion of said gas inlet body engaging the valve core seat; the valve core seat being embedded into the valve core seat chamber;
the machine further including a bush, a positioning ring, a steel ball and a spring; the positioning ring being fitted into the bush, the steel ball being embedded into a hole and engaging the annular positioning groove; the steel ball engaging the positioning ring
the spring fitting over a lower segment of the gas inlet body, an upper end of the spring engaging the block plate of the gas inlet body, and its lower end engaging the positioning ring.

8. The soda machine according to claim 7, further including a push-button connecting rod, which is pivotally connected to a frame, and its end engages the drive rod.
